(19) United States
(12) Patent Application Publication
(10) Pub. No.: US 2022/0065625 A1
(43) Pub. Date: Mar. 3, 2022

(54) INCLINOMETER FOR BASE STATION ANTENNA

(71) Applicant: CommScope Technologies LLC, Hickory, NC (US)

(72) Inventors: YongFeng Liu, Suzhou (CN); HanXing Xu, Suzhou (CN); ZhaoHui Liu, Suzhou (CN)

(21) Appl. No.: 17/391,396

(22) Filed: Aug. 2, 2021

(30) Foreign Application Priority Data
Sep. 1, 2020 (CN) 202010902178.0

(51) Int. Cl. G01C 9/10

(52) U.S. Cl. CPC G01C 9/10; H01Q 1/246

(57) ABSTRACT

The present disclosure relates to an inclinometer for base station antennas, wherein the inclinometer is configured to be mounted to the base station antenna, and comprises: a movable weight configured to move to and stay at the force balance position in dependence on the mechanical tilt of the base station antenna under the action of gravity of the weight; an indicator coupled to the movement of the weight; and a plurality of graduations used in cooperation with the indicator for reading the mechanical tilt of the base station antenna. With the aid of this inclinometer, the mechanical tilt of the base station antenna can be easily and intuitively obtained.

### RELATED APPLICATION

The present application claims priority from and the benefit of Chinese Application No. 202010902178.0, filed Sep. 1, 2020, the disclosure of which is hereby incorporated herein in full by reference.

### FIELD OF THE INVENTION

The present disclosure relates to the technical field of base station antennas, and more particularly, to an inclinometer for base station antennas, which is configured to indicate the mechanical tilt of the base station antennas.

### BACKGROUND OF THE INVENTION

A mobile communication network includes a large number of base stations, and the base stations include base station antennas used for receiving and/or transmitting radio frequency signals. The base station antennas are installed on communication towers or other structures. The base station antenna occupies a preset attitude at the installation position, e.g., a preset mechanical tilt. The mechanical tilt of a base station antenna can be measured and calculated by a measuring device and a calculating device, which could be costly.

### SUMMARY OF THE INVENTION

The present disclosure aims to provide an inclinometer for base station antenna, by means of which the mechanical tilt of a base station antenna can be easily obtained.

The object is achieved by an inclinometer for base station antennas, which is configured to be mounted to the base station antenna, the inclinometer comprising:

a movable weight configured to move to and stay at a force balance position in dependence on the mechanical tilt of the base station antenna under the action of gravity of the weight;

an indicator coupled to the movement of the weight; and

a plurality of graduations, which cooperate with the indicator to read the mechanical tilt of the base station antenna.

With this inclinometer, the mechanical tilt of a base station antenna at the installation position can be easily read. This facilitates the installation of base station antennas and the adjustment in operation after installation.

In some embodiments, the weight is a sphere.

In some embodiments, the weight is a sliding member.

In some embodiments, the weight and the indicator are of the same component, or are of two different components.

In some embodiments, the sphere constitutes the indicator.

In some embodiments, the inclinometer includes a dial, and the dial has the plurality of graduations.

In some embodiments, the inclinometer has a curved motion track in which the weight is received and observable.

In some embodiments, the graduations are distributed along the circumferential extension of the motion track.

In some embodiments, the dial is a transparent or translucent component.

In some embodiments, the inclinometer includes a support plate configured for mounting to a base station antenna.

In some embodiments, the dial is mounted on the support plate.

In some embodiments, the motion track is formed by a tubular body.

In some embodiments, the motion track is formed integrally with the dial, for example, by a groove in the dial.

In some embodiments, the inclinometer includes an enclosing element that encloses the groove and keeps the sphere in the groove.

In some embodiments, the enclosing element is a double-sided adhesive element, with one side adhered to the support plate, and the other side adhered to the dial, thus enclosing the motion track.

In some embodiments, the dial is adhered to the radome of the base station antenna, where a double-sided adhesive element is used, with one adhesive surface adhered to the radome of the base station antenna, and the other adhesive surface adhered to the dial.

In some embodiments, the enclosing element is colored, thus making it easier and clearer for the user to observe the sphere.

In some embodiments, the weight is configured to be pivotally mounted relative to the base station antenna.

In some embodiments, the weight and the indicator are formed as separate components and in movement coupling through a transmission device.

In some embodiments, the transmission is a gear transmission device.

A rack and pinion transmission device can be understood as a gear transmission device, in which a rack can be understood as a gear with an infinite diameter.

In some embodiments, the gear transmission device includes a fixed axis gear train and/or an epicyclic gear train.

In some embodiments, the gear transmission device includes a cylindrical gear and/or a conical gear.

In some embodiments, the gear transmission device is configured as a gear-ratioed transmission device.

In some embodiments, the gear transmission device comprises a first gear or gear sector and a second gear or gear sector, wherein the weight is connected with the first gear or gear sector, the indicator is connected with the second gear or gear sector, the first gear or gear sector meshes with the second gear or gear sector, and the diameter of the first gear or gear sector is larger than that of the second gear or gear sector.

In some embodiments, the diameter of the first gear or gear sector is at least 2 times, e.g., 3 times or 4 times, the diameter of the second gear or gear sector. In other words, the transmission ratio of this gear transmission device is not more than ½, e.g., ⅓ or ¼, or the gear ratio of this gear transmission device is not less than 2, e.g., 3 or 4. Compared with the case of direct transmission (transmission ratio=1), the distance between the graduations can be increased by increasing the transmission speed, making it easier to read the mechanical tilt.

In some embodiments, the weight is integrally connected with the first gear sector.

In some embodiments, the indicator shown is constructed separately from the second gear sector and fixed on the second gear sector.

In some embodiments, the weight is formed diametrically opposite to the pivot axis of the first gear sector about the weight.

In some embodiments, the weight and the first gear sector are symmetrically constructed about the diameter line passing through the pivot axis of the weight.

In some embodiments, the weight is pivotally mounted on the support plate.

In some embodiments, the gear transmission device is mounted on the support plate.

In some embodiments, the first gear or gear sector is pivotally mounted on the support plate.

In some embodiments, the second gear or gear sector is pivotally mounted on the support plate.

In some embodiments, the dial is fixedly mounted on the support plate.

The technical characteristics mentioned above, the technical characteristics to be mentioned below, and the technical characteristics which may be obtained from the drawings may be combined arbitrarily as long as these technical characteristics do not conflict with each other. All technically feasible characteristic combinations are technical contents stated in the disclosure.

### BRIEF DESCRIPTION OF THE DRAWINGS

The present disclosure is described in detail below by reference to the embodiments and the attached drawings. In which:

FIG. 1 is a perspective view of an inclinometer according to a first embodiment of the present disclosure.

FIG. 2 is an exploded view of the inclinometer of FIG. 1.

FIG. 3A is a side view of the base station antenna with the inclinometer of FIG. 1 in an installed state.

FIG. 3B is an enlarged view of the inclinometer in FIG. 3A.

FIG. 4A is a side view of the base station antenna with the inclinometer of FIG. 1 in another installation state.

FIG. 4B is an enlarged view of the inclinometer in FIG. 4A.

FIG. 5 is a plane view of an inclinometer according to a second embodiment of the present disclosure.

FIG. 6 is an exploded view of the inclinometer of FIG. 5.

FIG. 7A is a side view of the base station antenna with the inclinometer of FIG. 5 in an installed state.

FIG. 7B is an enlarged view of the inclinometer in FIG. 7A.

FIG. 8A is a side view of the base station antenna with the inclinometer of FIG. 5 in another installation state.

FIG. 8B is an enlarged view of the inclinometer in FIG. 8A.

### DETAILED DESCRIPTION OF THE INVENTION

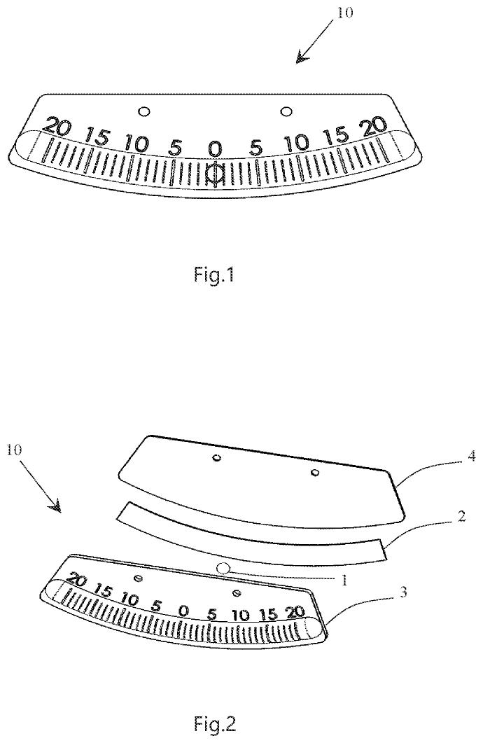

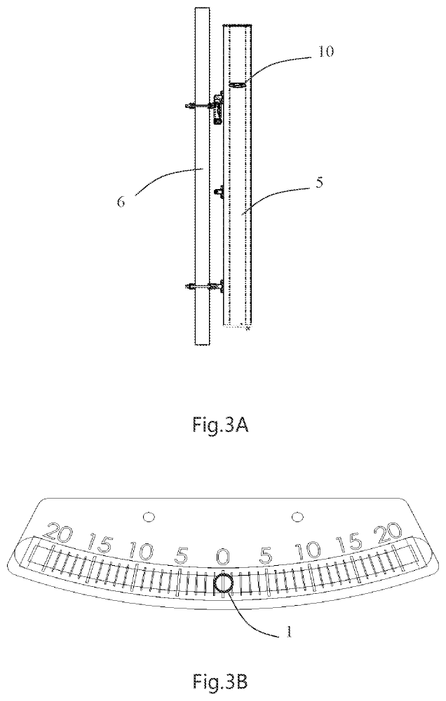

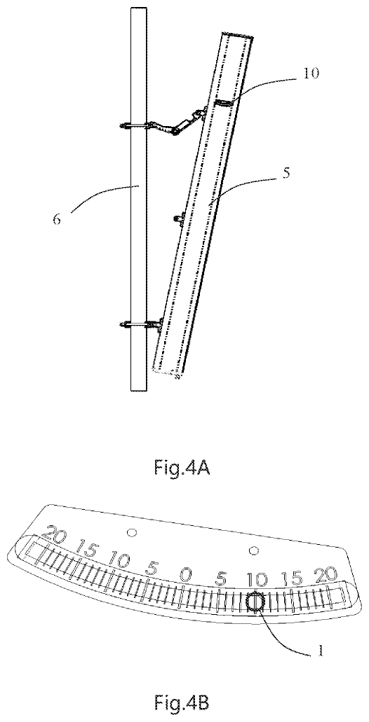

The inclinometer 10 for the base station antenna 5 according to a first embodiment of the present disclosure will be described with reference to FIGS. 1, 2, 3A and 3B, and 4A and 413, wherein FIGS. 1 and 2 are perspective and exploded views of the inclinometer 10 according to a first embodiment, FIGS. 3A and 3B describe the base station antenna 5 mounted on a mounting structure 6 at a mechanical tilt of about 0 degree (the longitudinal axis of the base station antenna is parallel to the vertical line), and FIGS. 4A and 4B describe the base station antenna 5 mounted on the mounting structure 6 at a mechanical tilt of about 10 degrees (the vertical axis of the base station antenna forms an angle of about 10 degrees with the vertical line).

The inclinometer 10 includes a sphere as the movable weight 1, and the sphere also serves as an indicator. The inclinometer 10 has a curved motion track in which a sphere is received and movable. The inclinometer has a dial 3, which has a plurality of graduations. The graduations of the dial 3 are distributed along the circumferential extension of the motion track. As shown exemplarily, the maximum graduation value is selected as 20 degrees, because the mechanical tilt typically does not exceed 20 degrees. The dial 3 is a transparent or translucent component, so that the sphere 1 can be observed through the dial 3. The inclinometer 10 has a support plate 4, and the dial 3 is mounted on the support plate 4. In a first embodiment as shown in FIG. 1 and FIG. 2, the motion track is formed by the dial 3. For this purpose, the dial 3 has a curved groove. In addition, the inclinometer 10 has an enclosing element 2, which encloses the groove of the dial 3, so that the sphere 1 is held in the groove. The enclosing element 2 is colored to make the observation of the sphere 1 easier and clearer. The enclosing element 2 is a double-sided adhesive element, with one adhesive surface adhered to the dial 3 and the other adhesive surface adhered to the support plate 4. The support plate 4 is fixed on the radome of the base station antenna 5 by means of fastening elements such as screws.

In some embodiments not shown, the motion track is formed separately from the dial 3, e.g., by a single tubular body. In some embodiments not shown, the motion track is formed by two half-shells, with one half-shell forming a separate component and the other half-shell integrated with the dial 3.

In some embodiments not shown, instead of the support plate 4 and the enclosing element 2, a double-sided adhesive element with a larger area is used, which has two opposite adhesive surfaces, with one adhesive surface for adhering to the radome of the base station antenna 5, and the other adhesive surface for adhering to the dial 3, so that the dial 3 can be directly adhered to the base station antenna 5 through the double-sided adhesive element.

In some embodiments not shown, the plurality of graduations is provided on the enclosing element 2 or on the support plate 4, and the original dial 3 no longer has the plurality of graduations.

Also, in some embodiments the sphere may be replaced with a non-spherical member that can slide within the track formed by the support plate 2 and enclosing element 4 (e.g., an oval, square, rectangular, or other-shaped member).

In the mounting position of the base station antenna 5 shown in FIG. 3A, the base station antenna 5 has a mechanical tilt of about 0 degree. As shown in FIG. 3B, the sphere of the inclinometer 10 is in a position with a graduation value of zero at the force balance position in the motion track. In the installation position of the base station antenna 5 shown in FIG. 4A, the base station antenna 5 has a mechanical tilt of about 10 degrees. As shown in FIG. 4B, the sphere 1 of the inclinometer 10 is in a position with a graduation value of about 10 at the force balance position in the motion track. The current mechanical tilt of the base station antenna 5 can be easily obtained by observing the inclinometer 10. Therefore, it is possible to easily place the base station antenna 5 in a preset mechanical tilt when mounting the base station antenna 5 or when readjusting the base station antenna 5 after mounting. When adjusting from the state shown in FIG. 3A to the state shown in FIG. 4A, the fixed component of the inclinometer 10 relative to the base station antenna 5 rotates together with the base station antenna 5, and the sphere 1 of the inclinometer 10 moves in the motion track under the action of its own gravity until it reaches and stops at the new force balance position, and the reading of the mechanical tilt is indicated for the new force balance position.

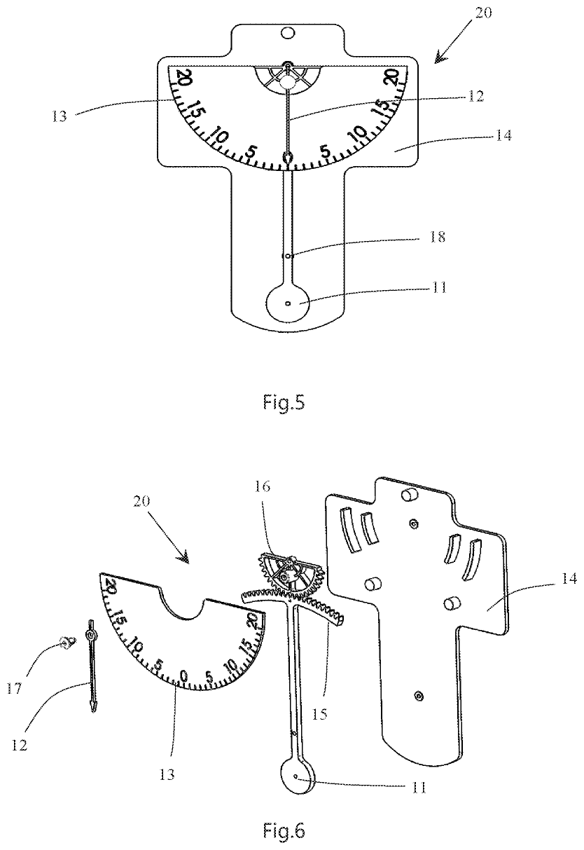

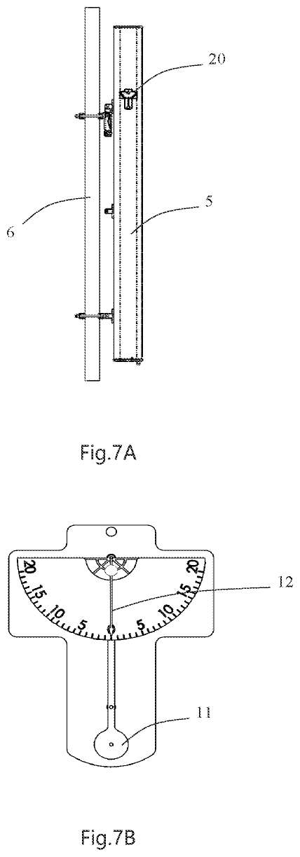

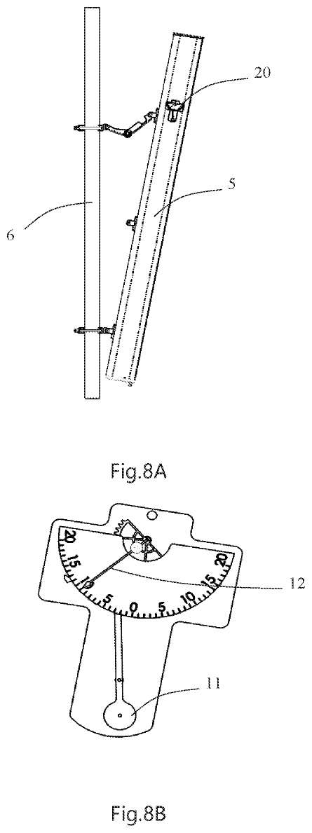

Next, the inclinometer 20 for the base station antenna 5 according to a second embodiment of the present disclosure will be described with reference to FIGS. 5, 6, 7A and 7B, and 8A and 8B, wherein FIGS. 5 and 6 are plane views and exploded views of the inclinometer 20 according to a second embodiment, FIGS. 7A and 7B describe the base station antenna 5 mounted on the mounting structure 6 with a mechanical tilt of about 0 degree, and FIGS. 8A and 8B describe the base station antenna 5 mounted on the mounting structure 6 with a mechanical tilt of about 10 degrees.

The inclinometer 20 includes a weight 11, an indicator 12, a dial 13 and a support plate 14. The weight 11 and the indicator 12 are in movement coupling through a gear transmission device. The weight 11, the indicator 12, the dial 13 and the gear transmission device are mounted on the support plate 14. The support plate 14 can be fixed on the radome of the base station antenna 5 by means of fastening elements. The weight 11 is pivotally mounted on the support plate 14 about the pivot axis 18. The gear transmission device includes a first gear sector 15 and a second gear sector 16. The weight 11 is connected with the first gear sector 15 to form and integration so as to rotate together around the pivot axis 18. The weight 11 and the first gear sector 15 are diametrically arranged with respect to the pivot axis 18 of the weight 11. The indicator 12 is connected with the second gear sector 16, e.g., by fixing on the second gear sector 16 by screws 17 so as to rotate together with the second gear sector 16. The first gear sector 15 meshes with the second gear sector 16, and the diameter of the first gear sector 15 is larger than that of the second gear sector 16. In the illustrated embodiment, the diameter of the first gear sector 15 is about four times that of the second gear sector 16, and therefore this gear transmission device has a gear ratio of ¼. In some embodiments not shown, instead of the gear sector, a gear or a rack is used. In some embodiments not shown, more gears or gear sectors are provided.

The dial 13 has a plurality of graduations. As shown exemplarily, the maximum graduation value is selected as 20 degrees, because the mechanical tilt typically does not exceed 20 degrees. In some embodiments not shown, the separate dial 13 is eliminated, and the plurality of graduations are directly provided on the support plate 14.

In the mounting position of the base station antenna 5 shown in FIG. 7A, the base station antenna 5 has a mechanical tilt of about 0 degree. As shown in FIG. 7B, the indicator 12 of the inclinometer 20 is in a position with a graduation value of zero at the force balance position. In the installation position of the base station antenna 5 shown in FIG. 8A, the base station antenna 5 has a mechanical tilt of about 10 degrees. As shown in FIG. 8B, the indicator 12 of the inclinometer 20 is in a position with a graduation value of about 10 at the force balance position. The current mechanical tilt of the base station antenna 5 can be easily obtained by observing the inclinometer 20. Therefore, it is possible to easily place the base station antenna 5 in a preset mechanical tilt when mounting the base station antenna 5 or when readjusting the base station antenna 5 after mounting. When adjusting from the state shown in FIG. 7A to the state shown in FIG. 8A, the fixed component of the inclinometer 20 relative to the base station antenna 5 rotates together with the base station antenna 5, the weight 11 of the inclinometer 20 is kept in a substantially vertical position under the action of its own gravity, and therefore the weight 11 together with the first gear sector 15 rotates around the pivot axis 18 relative to the base station antenna 5. Then, the second gear sector 16 together with the indicator 12 also rotates relative to the base station antenna 5 and the dial 13, so that the indicator 12 indicates the current mechanical tilt of the base station antenna 5 in relation to this relative rotation.

Optionally, the inclinometer may have a cover to protect it from external influences. The cover may either be another separate component, or be partially or completely composed of the component of the inclinometer already mentioned above. Advantageously, the cover is a transparent or translucent component, so that the mechanical tilt of the base station antenna can be read from the inclinometer directly through the cover. Advantageously, the inclinometer is at least partially sealed from the external environment, so that, e.g., intrusion of rainwater can be prevented.

It will be understood that, the terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprise” and “include” (and variants thereof), when used in this specification, specify the presence of stated operations, elements, and/or components, but do not preclude the presence or addition of one or more other operations, elements, components, and/or groups thereof. As used herein, the term “and/or” includes any and all combinations of one or more of the associated listed items. Like reference numbers signify like elements throughout the description of the figures.

The thicknesses of elements in the drawings may be exaggerated for the sake of clarity. Further, it will be understood that when an element is referred to as being “on,” “coupled to” or “connected to” another element, the element may be formed directly on, coupled to or connected to the other element, or there may be one or more intervening elements therebetween. In contrast, terms such as “directly on,” “directly coupled to” and “directly connected to,” when used herein, indicate that no intervening elements are present. Other words used to describe the relationship between elements should be interpreted in a like fashion (i.e., “between” versus “directly between”, “attached” versus “directly attached,” “adjacent” versus “directly adjacent”, etc.).

Terms such as “top,” “bottom,” “upper,” “lower,” “above,” “below,” and the like are used herein to describe the relationship of one element, layer or region to another element, layer or region as illustrated in the figures. It will be understood that these terms are intended to encompass different orientations of the device in addition to the orientation depicted in the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive concept.

It will also be appreciated that all example embodiments disclosed herein can be combined in any way.

Finally, it is to be noted that, the above-described embodiments are merely for understanding the present invention but not constitute a limit on the protection scope of the present invention. For those skilled in the art, modifications may be made on the basis of the above-described embodiments, and these modifications do not depart from the protection scope of the present invention.

1. An inclinometer for a base station antenna, wherein the inclinometer is configured to be mounted to the base station antenna, and the inclinometer comprises:
a movable weight configured to move to and stay at a force balance position in dependence on a mechanical tilt of the base station antenna under the action of gravity of the weight;
an indicator in movement coupling to the weight; and
a plurality of graduations, which cooperate with the indicator to read the mechanical tilt of the base station antenna.

2. The inclinometer for base station antennas according to claim 1, wherein the weight is configured to be pivotally mounted relative to the base station antenna.

3. The inclinometer for base station antennas according to claim 2, wherein the weight and the indicator are formed as two separate components and are in movement coupling through a gear transmission device.

4. The inclinometer for base station antenna according to claim 3, wherein the gear transmission device is an overdrive transmission device.

5. The inclinometer for base station antenna according to claim 3, wherein the gear transmission device comprises a. first gear or gear sector and a second gear or sector, the weight is connected with the first gear or gear sector, the indicator is connected with the second gear or gear sector, the first gear or gear sector meshes with the second gear or gear sector, and a diameter of the first gear or gear sector is larger than a diameter of the second gear or gear sector.

6. The inclinometer for base station antennas according to claim 5, wherein the diameter of the first gear or gear sector is at least twice that of the second gear or gear sector.

7. The inclinometer for base station antennas according to claim 5, wherein the weight is integrally connected with the first gear sector, and the indicator is formed separately from and fixed to the second gear sector.

8. The inclinometer for base station antennas according to claim 7, wherein the weight and the first gear sector are formed diametrically opposite to each other about a pivot axis of the weight.

9. The inclinometer for base station antennas according to claim 2, wherein the inclinometer comprises a support plate configured to be mounted to the base station antenna, and the weight is pivotally mounted on the support plate.

10. The inclinometer for base station antennas according to claim 5, wherein the inclinometer comprises a support plate configured to be mounted to the base station antenna, the weight is pivotally mounted on the support plate, and the second gear sector is pivotally mounted on the support plate,

11. The inclinometer for base station antennas according to claim 9, wherein the inclinometer comprises a dial having the plurality of graduations, and the dial is fixedly mounted on the support plate.

12. The inclinometer for base station antennas according to claim 1, wherein the weight is a sphere, and the sphere forms the indicator.

13. The inclinometer for base station antennas according to claim 12, wherein the inclinometer comprises a dial having the plurality of graduations.

14. The inclinometer for base station antennas according to claim 12, wherein the inclinometer has a curved motion track, the weight is received and observable in the motion track, and the graduations are distributed along a. circumferential extension of the motion track.

15. The inclinometer for base station antennas according to claim 14, wherein the inclinometer comprises a dial having the plurality of graduations, the dial is a transparent or translucent component, and the motion track is formed by a groove in the dial.

16. The inclinometer for base station antennas according to claim 15, wherein the inclinometer comprises an enclosing element which encloses the groove and keeps the sphere in the groove.

17. The inclinometer for base station antennas according to claim 16, wherein the enclosing element is colored.

18. The inclinometer for base station antennas according to claim 15, wherein the inclinometer comprises a support plate configured to be mounted to the base station antenna, and the dial is fixed on the support plate.
